(19) United States
(12) Patent Application Publication
(10) Pub. No.: US 2022/0219179 A1
(43) Pub. Date: Jul. 14, 2022

(54) SPRAY SYSTEM AND METHOD OF SPRAYING

(71) Applicant: PPG Europe B.V, Uithoorn (NL)

(72) Inventors: Michael Jansen, Soest (NL); Joseph Verhoosel, Bergen (NL)

(73) Assignee: PPG Europe B.V, Uithoorn (NL)

(21) Appl. No.: 17/610,176

(22) PCT Filed: May 10, 2019
(86) PCT No.: PCT/EP2019/062086

§ 371 Date: Nov. 10, 2021

(51) Int. Cl. B05B 7/24; B05B 12/00; B05B 15/62

(52) U.S. Cl. CPC B05B 7/241; B05B 12/0026; B05B 7/2416; B05B 15/62; B05B 7/2481; B05B 7/2491; B05B 7/2494; B05B 7/2475

(57) ABSTRACT

A liquid spray system (1e) and method of using a liquid spray system is shown. The spray system (1e) comprises a receptacle (100e) for holding liquid to be sprayed, a support structure (200e) for supporting the receptacle (100e), a spray applicator (300e) disposed remotely from the support structure (200e) and an air pressurising device for driving the liquid out of the receptacle (100e) and for mixing with the liquid at an outlet of the spray applicator (300e). Advantageously, the spray system (1e) is compact and versatile.

### FIELD

The present disclosure relates in general to liquid spray systems and methods of using liquid spray systems, particularly, although not exclusively for spraying paint.

### BACKGROUND

Conventionally, a surface to be painted is painted by hand using a brush, pad or roller (conventional applicators). Although painting by brush, in particular, can be accurate, the application of paint onto a surface in this manner is slow. The use of a pad or roller helps to speed-up the painting process compared to the use of a brush (albeit at the cost of some accuracy). Nevertheless, all of the aforementioned approaches require paint to be frequently absorbed onto the specific conventional applicator before the paint can be transferred to the surface to be painted.

Another conventional paint application approach is to spray the paint toward a surface. Spraying is more efficient and faster than direct contact of the applicator to the surface because the sprayed paint is typically applied in a continuous or semi-continuous manner from a reservoir. Furthermore, the coverage of paint onto a surface is generally more consistent than a brush, pad or roller application and possible accumulation of paint (i.e. unwanted lumps) are avoided. However, as the spraying technique relies on the adhesion properties of the paint to the surface, some spray systems lead to splashback (also known as bounce back) of the paint. This is because not all of the sprayed paint is capable of adhering to the surface and is consequently repelled away from the surface.

Another disadvantage of conventional spray systems is that it is often difficult to control the quality of an edge finish. In particular, problems such as drift of the paint can led to overspray, i.e. application of the paint onto an unintended location. To overcome this problem, high-pressure spray systems may be used to ensure effective application of the paint. However, high-pressure spray systems may increase the risk of splashback.

Both splashback and overspray are problematic because nearby surfaces (including those on the user) may become inadvertently coated. Nearby surfaces are often therefore cleaned after the spray application or covered beforehand. If splashback and overspray can be minimised, the need to extensively mask surfaces, which is time and cost inefficient, can be significantly reduced.

It is desirable to provide a spray system and method of using a spray system that is more convenient than known systems. A spray system that is also more accurate is desirable. Furthermore, it is desirable that the system is easy to use and/or easy to transport. It is an object of aspects of the present disclosure to address one or more of the above mentioned or other problems.

### SUMMARY

According to a first aspect of the present disclosure there is provided a liquid spray system comprising:
a receptacle for holding liquid, the receptacle comprising:
   a main body;
   a reservoir having a liquid outlet;
   a displacement member moveable within the main body for varying a capacity of the reservoir and having a liquid contacting side and an air contacting side;
   an air inlet in fluid communication with the air contacting side of the displacement member;
a support structure for supporting the receptacle;
a spray applicator comprising:
   a liquid inlet for receiving liquid from the liquid outlet of the reservoir;
   a liquid outlet;
   a liquid outlet valve for controlling the release of liquid via the liquid outlet;
   a trigger for controlling the outlet valve; and
an air pressurising device in fluid communication with the air contacting side of the displacement member and arranged to be operable to move the displacement member, in use; the air pressurising device also being in fluid communication with the liquid outlet valve of the spray applicator and being arranged to be operable to propel liquid out of the liquid outlet valve of the spray applicator, in use.

The displacement member suitably comprises a flexible membrane.

The flexible membrane is suitably coupled to the main body of the receptacle at a portion of the air inlet and a portion of the liquid outlet.

The liquid outlet portion of the reservoir and air inlet portion of the receptacle are suitably arranged at or towards opposite ends of the receptacle.

The main body suitably comprises a coating arranged on an air contacting side for preventing adhesion of the flexible membrane with the main body.

The support structure suitably comprises an accommodating part for receiving the receptacle. The receptacle may be a cartridge. The cartridge suitably comprises a one-way valve for restricting liquid flow into the cartridge.

Suitably, the air inlet of the liquid spray system comprises the one-way valve.

The receptacle suitably comprises a pressure relief valve operable to equalise pressure on the air side of the displacement member with ambient air.

The support structure suitably comprises a connecting member interposed between the liquid outlet portion of the reservoir and the liquid inlet of the spray applicator. Suitably, the connecting member is connectable to a first transmission line for transmitting liquid from the liquid outlet portion of the reservoir to the connecting member and a second transmission line for transmitting liquid away from the connecting member and to the liquid inlet of the spray applicator.

The support structure suitably comprises a receptacle holding part and a ground contacting part wherein the ground contacting part is moveable relative to the receptacle holding part for guiding the receptacle holding part over ground.

Suitably, the support structure is arranged for supporting the air pressurising device. The support structure may be wearable on a user.

The liquid spray system may further comprise a control valve for restricting propellant air supplied by the air pressurising device in fluid communication with the outlet valve of the spray applicator to a pressure of less than 3 bar.

The support structure is suitably arranged to encase the receptacle.

The air pressurising device may comprise a compressor.

The liquid of the liquid spray system suitably comprises paint or varnish. The paint or varnish may be any suitable paint or varnish. For example, the paint may be a solvent or water based lacquer. Suitable lacquers may include oxidative drying solvent or water based alkyd or acrylic lacquers.

The liquid spray system may be used in conjunction with a vehicle. The liquid spray system may be at least partially or wholly mounted on or in the vehicle. The entire liquid spray system may be mounted on or in the vehicle. The spray applicator may be mounted on an arm of the vehicle, suitably an extendable arm of the vehicle.

The liquid spray system may be used in conjunction with an unmanned aerial vehicle (UAV), such as a drone. The liquid spray system may be at least partially or wholly mounted on or in an unmanned aerial vehicle (UAV). The entire liquid spray system may be mounted on or in an unmanned aerial vehicle (UAV).

The spray applicator may be mounted on or in an unmanned aerial vehicle (UAV). The spray applicator may be mounted on or in an unmanned aerial vehicle (UAV), while the receptacle for holding liquid may be mounted not on the unmanned aerial vehicle (UAV). The receptacle for holding liquid may be connected to the UAV mounted spray applicator by one or more delivery conduits. The delivery conduits may suitably be operable to deliver the liquid spray and pressured air from the air pressurizing device. Suitably, such an arrangement allows for the UAV to administer the liquid spray at a position remote from the receptacle for holding liquid.

The unmanned aerial vehicle (UAV) may operate under remote control by a human operator or autonomously by onboard sensors/computers.

According to a second aspect of the present disclosure there is provided a method of using a liquid spray system comprising the steps of:
filling a reservoir of a receptacle with liquid;
loading the receptacle into a support structure;
supplying gas to a displacement member of the receptacle from a gas pressurising device;
moving the displacement member relative to a main body of the receptacle with gas supplied by the gas pressurising device;
guiding liquid from the reservoir towards a spray applicator;
activating a trigger of the spray applicator; and
propelling liquid from an outlet valve of the spray applicator using gas from the gas pressurising device as propellant.

The method may comprise filling the reservoir with liquid during manufacture and providing the receptacle as a cartridge.

The method may comprise disturbing a tamper-proofing means comprised by the cartridge. The method may comprise disturb the tamper-proofing means during loading the cartridge into the support structure.

The method may comprise releasing gas from a gas side of the displacement member using a pressure relief valve for equalising pressure with ambient air.

The method may comprise wearing the support structure.

The gas used in the method suitably comprises air.

The liquid of the method is suitably a coating composition, such as a paint composition or a varnish composition. The paint or varnish may be any suitable paint or varnish. For example, the paint or varnish may be a solvent or water based lacquer. Suitable lacquers may include oxidative drying solvent or water based alkyd or acrylic lacquers.

According to a third aspect of the present disclosure there is provided a kit of parts for a liquid spray system comprising:
a cartridge filled with liquid for spraying;
a support structure for supporting the cartridge;
a spray applicator; and
an air pressurising device.

According to a fourth aspect of the disclosure there is provided a liquid spray system comprising:

a support structure configured to support a receptacle, the receptacle for holding liquid, the receptacle comprising:

a main body;

a reservoir having a liquid outlet;

a displacement member moveable within the main body for varying a capacity of the reservoir and having a liquid contacting side and an air contacting side; and

an air inlet in fluid communication with the air contacting side of the displacement member;
a spray applicator disposed remotely from the support structure comprising:

a liquid inlet for receiving liquid from the liquid outlet of the reservoir;

a liquid outlet;

a liquid outlet valve for controlling the release of liquid via the liquid outlet;

a trigger for controlling the outlet valve; and

wherein the system is configured to be connected to an air pressurising device so that the air pressurising device is in fluid communication with:

the air contacting side of the displacement member, so as to move the displacement member, in use; and

the liquid outlet valve of the spray applicator, so as to propel liquid out of the liquid outlet valve of the spray applicator, in use.

The support structure may comprise an accommodating part configured to receive the receptacle. The accommodating part may define a recess having a shape at least partially corresponding to a shape of the receptacle. The support structure may comprise an enclosure having an interior volume, the enclosure comprising the accommodating part. The support structure may comprise a door configured to open and close the enclosure. The support structure may be wearable on a user. The support structure may be configured to be disposed on a floor or other support surface whilst the spray applicator is held in a hand of a user. The liquid spray system may comprise a liquid transmission line extending between the support structure and the spray applicator, wherein a length of the liquid transmission line is 0.5 m or greater.

The support structure may comprise a spray applicator holder, configured to retain the spray applicator when not in use. The spray applicator holder may be configured to prevent activation of the trigger of the spray applicator when retaining the spray applicator.

The displacement member may comprise a flexible membrane.

A liquid outlet portion of the reservoir and an air inlet portion of the receptacle may be arranged at or towards opposite ends of the receptacle.

The receptacle may comprise a one-way valve for restricting liquid flow into the cartridge.

The support structure may be arranged for supporting the air pressurising device. The air pressurising device may comprise a compressor. The system may comprise the air pressurising device.

The system may comprise the receptacle. The receptacle may comprise the liquid. The liquid may comprise a coating, such as a paint or varnish.

According to a fifth aspect of the disclosure there is provided a method of using a liquid spray system comprising the steps of:
loading a receptacle comprising a reservoir of liquid into a support structure;
supplying gas to a displacement member of the receptacle from a gas pressurising device;
moving the displacement member relative to a main body of the receptacle with gas supplied by the gas pressurising device;
guiding liquid from the reservoir towards a spray applicator; and
propelling liquid from an outlet valve of the spray applicator using gas from the gas pressurising device as propellant upon activation of a trigger of the spray applicator.

The method may comprise filling the reservoir with liquid. The method may comprise wearing the support structure. The gas may comprise air. The liquid may be a coating composition, such as a paint or varnish.

According to a sixth aspect of the disclosure there is provided an assembly for a liquid spray system comprising:
a support structure configured to support a receptacle, the receptacle (100) for holding liquid, the receptacle comprising:
   a main body;
   a reservoir having a liquid outlet;
   a displacement member moveable within the main body for varying a capacity of the reservoir and having a liquid contacting side and an air contacting side;
   an air inlet in fluid communication with the air contacting side of the displacement member; and
a spray applicator connectable to the support structure so as to be disposed remotely therefrom comprising:
   a liquid inlet for receiving liquid from the liquid outlet of the reservoir;
   a liquid outlet;
   a liquid outlet valve for controlling the release of liquid via the liquid outlet;
a trigger for controlling the outlet valve,

wherein the assembly is configured to be connected to an air pressurising device so as to place the air pressurising device in fluid communication with:
the air contacting side of the displacement member, so as to move the displacement member, in use; and
the liquid outlet valve of the spray applicator, so as to propel liquid out of the liquid outlet valve of the spray applicator, in use.

The assembly may comprise the air pressurising device.

The assembly may comprise the receptacle. The receptacle may comprise the liquid. The liquid may comprise a coating, such as a paint or varnish.

A seventh aspect of the disclosure provides use of a receptacle for holding a coating composition in a liquid spray system, the receptacle comprising:

a main body;

a reservoir holding a coating composition and having a liquid outlet;

a displacement member moveable within the main body for varying a capacity of the reservoir and having a liquid contacting side and an air contacting side; and

an air inlet in fluid communication with the air contacting side of the displacement member.

The liquid spray system may comprise the liquid spray system as defined in the first aspect, or as otherwise defined herein.

Further suitable features of the disclosure may become apparent from the further description, hereunder. It will be understood that these suitable features may be combined with any of the aspects defined herein. The liquid spray system may comprise a receptacle for holding liquid. The receptacle may suitably comprise a container for storing liquid. The receptacle includes a main body and a displacement member movable within the main body. The displacement member may therefore suitably comprise a moveable member. The main body may suitably comprise an outer part of the receptacle and enclose the displacement member.

The receptacle comprises a reservoir having a reservoir outlet, suitably adapted to allow release of the liquid from the reservoir. The displacement member is suitably configured to move relative to the main body in order to vary the capacity of the reservoir. The displacement member comprises a liquid contacting side and an air contacting side. The liquid contacting side and the air contacting side may be permanent in that, when liquid is present in the receptacle, the liquid is always present on the liquid contacting side. The receptacle further comprises an air inlet. The air inlet is communicable with the air contacting side of the displacement member. That is, the air inlet is in fluid communication with air contacting side of the displacement member. The spray system further comprises a support structure for supporting the receptacle. That is, the support structure suitably restricts movement of the receptacle relative to the support structure. Therefore, when the receptacle is coupled to the support structure, the receptacle and support structure are suitably provided as one body.

The spray system comprises a spray applicator. The spray applicator is suitably configured to release liquid from the spray system in the form of spray. The spray applicator comprises a liquid inlet for receiving liquid from the liquid outlet of the reservoir, a liquid outlet, a liquid outlet valve for controlling the release of liquid via the liquid outlet and a trigger for controlling the outlet valve. That is, the outlet valve is suitably a trigger-operated valve, wherein activation of the trigger (which may comprise movement) may produce movement in the outlet valve.

The spray applicator may be located remotely from the receptacle and/or support structure. That is to say, the spray applicator may not comprise the receptacle and/or support structure. The spray applicator and the receptacle and/or support structure may be configured for relative movement in use. The receptacle and/or support structure may be connected to the spray applicator solely by liquid transmission lines and air transmission lines as defined herein, so that suitably there is no other structural link between the receptacle/support structure and the spray applicator.

The spray system may further comprise an air pressurising device. The air pressurising device is in fluid communication with the air contacting side of the displacement member and is arranged to be operable to move the displacement member, in use. The air pressurising device is also arranged to be in fluid communication with the liquid outlet valve of the spray applicator and is arranged to be operable to propel liquid out of the liquid outlet valve of the spray applicator, in use. The air pressuring device may be operable to provide a driving force to move the displacement member so that liquid is expelled from the reservoir and out of the spray applicator. The air from the air pressurizing device suitably atomises the liquid.

The receptacle may be provided as a cartridge. Advantageously, the receptacle is easy to install and the risk of liquid loss is reduced. The cartridge may be a refillable cartridge rather than a one-time use cartridge. Refilling the cartridge may only be possible by allowing air to be released from inside the receptacle to allow the displacement member to move.

The receptacle or cartridge may comprise a tamper-proofing means such as a tamperproof seal. The cartridge may comprise a one-way valve for restricting liquid flow into the cartridge. The air inlet of the receptacle may be the one-way valve. The one-way valve may be overridden to release air from the air contacting side of the displacement member. The receptacle may comprise a pressure relief valve for equalising pressure on the air side of the displacement member with ambient air. That is, the effect of a one-way valve may be overcome by the pressure relief valve.

The spray system may comprise a plurality of receptacles. Alternatively, the spray system may comprise a single receptacle that is in use at any one time and space for accommodating another receptacle that is not in use (i.e. liquid is not transportable to the spray applicator). The reservoir of each receptacle may have a different volumetric capacity. A plurality of receptacles may be in fluid communication with the spray applicator or only one receptacle at any one time may be in fluid communication with the spray applicator.

An inner wall of the main body that is configured to contact air rather than liquid may comprise a non-stick coating to allow the displacement member to contact the inner wall without sticking thereto. The non-stick coating may be a sprayable non-stick coating. The term non-stick refers to a reduction in tackiness such that abutting parts are prevented from being bonded to each other. The non-stick coating applied to the inner wall may have the effect of reducing the adherence of the displacement member to the main body such that the displacement member can move freely. When the displacement member comprises a flexible membrane, the main body may comprise a coating arranged on an air contacting side for preventing adhesion of the flexible membrane with the main body. The coating is therefore suitably a non-stick coating. The main body may comprise or be formed of a plastic material.

The main body may be cylindrical. The main body may comprise a neck within which the liquid outlet of the reservoir is arranged. The main body may be a pressure vessel to allow the reservoir to be under pressure. That is, the main body may resist deformation under liquid and/or air pressure.

The main body may define part of the reservoir. The portion of the main body forming part of the reservoir may be variable depending on the varying capacity of the reservoir. The displacement member alone may define the reservoir such that when the reservoir contains liquid the liquid is not configured to come into contact with the main body. The reservoir outlet may also function as an inlet but may only be operable when air is releasable from the air contacting side because air between the displacement member and the main body may prevent the reservoir from filling and/or refilling.

The displacement member may be slidably arranged relative to the main body. That is, the movement of the displacement member is suitably a sliding movement. The displacement member may be generally rigid or generally flexible.

The displacement member may comprise a flexible membrane that is operable as a bladder. The bladder may contract and expand. Expansion of the bladder may cause a reversible thinning of the membrane. The main body may determine a limit of expansion of the bladder, particularly an inner wall of the main body. The flexible membrane may be coupled to the main body of the receptacle at a portion of the air inlet and a portion of the liquid outlet. This ensures that the flexible membrane is held relative to the main body.

The liquid outlet portion of the reservoir and air inlet portion of the receptacle are arranged at or towards opposite ends of the receptacle. The air inlet portion may be arranged at a bottom portion of the receptacle. The air inlet portion may be arranged on a bottom surface or an underside of the receptacle. The liquid outlet portion may be arranged in a neck of the main body.

The support structure may comprise an accommodating part for receiving the receptacle. The accommodating part may define a recess having a shape at least partially corresponding to a shape of the receptacle. That is to say, the shape of the recess may be of a shape that is at least partially complementary to the shape of the receptacle. The support structure may comprise an enclosure having an interior volume. The enclosure may comprise the accommodating part. A door, or hatch, may be configured to open and close the enclosure.

A first liquid transmission line may interlink the receptacle and the spray applicator. The first liquid transmission line may have a length of 0.5 m or more. The first liquid transmission line may have a length of 0.7 m or more, or 0.8 m or more, or 0.9 m or more, or 1 m or more, or 1.1 m or more, or 1.2 m or more, or 1.3 m or more, or 1.5 m or more. A first air transmission line may interlink the air pressurising device and the receptacle. A second air transmission line may interlink the receptacle and the spray applicator.

A first liquid transmission line may interlink the receptacle and a control unit and a second liquid transmission line may interlink the control unit and the spray applicator. Additionally, a first air transmission line may interlink the air pressurising device and the control unit, a second air transmission line may interlink the control unit and the receptacle and a third air transmission line may interlink the control unit and the spray applicator.

The support structure may comprise a connecting member interposed between the liquid outlet portion of the reservoir and the liquid inlet of the spray applicator. The connecting member may be connectable to a first transmission line for transmitting liquid from the liquid outlet portion of the reservoir to the connecting member and a second transmission line for transmitting liquid away from the connecting member and to the liquid inlet of the spray applicator. The connecting member may comprise a control valve. That is, the connecting member may be a control unit for controlling the flow of liquid from the receptacle to the spray applicator. A first air transmission line and second air transmission line may be similarly connected either side of the connecting member, wherein the connecting member may comprise an air control valve. The control unit may control either or both of the air and liquid flows. The control unit may be wearable on a user, for example as a belt. The control unit may be attachable to the support structure.

The transmission lines may be elongate members having a passageway for the transportation of liquid or air. The elongate members may be flexible so that their orientation can be changed. A transmission line may comprise a hose.

The support structure may be arranged to support the air pressurising device. The air pressurising device may be enclosed by the support structure. The support structure may be wearable on a user. That is, the support structure may be provided in the form of a backpack. The spray applicator may be configured to be disposed in a hand of the user whilst the support structure is worn on the user.

The support structure may be arranged to encase the receptacle. The support structure may comprise a hatch for accessing the receptacle. The hatch may be pivotable. The hatch may comprise a transparent portion for visual inspection of an inside of the support structure.

The support structure may be configured to be disposed on a floor or other support surface. The spray applicator may be configured to be held in a hand of the user whilst the support structure is disposed on the floor or other support surface. The support structure may comprise a receptacle holding part and a ground contacting part. The ground contacting part may be moveable relative to the receptacle holding part for guiding the receptacle holding part over ground. The ground contacting part may comprise at least one wheel. Suitably, the ground contacting part comprises a plurality of wheels for stability. Therefore, the support structure may be provided in the form of a trolley.

The support structure may comprise a handle for manually gripping the support structure. The handle may be telescopic. The support structure may have a resting position that is configured to maintain a base of the receptacle parallel to a ground surface.

The spray applicator may be or comprise a spray gun. That is, the spray applicator may be holdable in a user's hand and the trigger may be operable by one or more of the user's fingers, such as a user's forefinger (index finger). The spray applicator may comprise a primary air outlet in fluid communication with the air pressurising device and the liquid outlet valve of the spray applicator.

The spray system may comprise a control valve for restricting propellant air supplied by the air pressurising device in fluid communication with the outlet valve of the spray applicator to a pressure of 3 bar or less. Suitably the pressure may be 2 bar or less. Suitably, the pressure is from 0.5 bar to 1 bar. For example, the pressure may be from 0.6 bar to 0.7 bar, such as about 0.62 bar. Such pressure may help to reduce turbulence and therefore improves control. Furthermore, the use of a relatively low air pressure allows the spray applicator to be positioned in close proximity to the surface to which the liquid is applied (e.g. 5 cm therefrom), without excessive splashback or overspray. Accordingly, the spray applicator can be positioned sufficiently close to the surface so that wind has limited interference on the sprayed liquid, thereby suitably rendering the liquid spray system conveniently operable outside (e.g. for coating the exterior of buildings).

The spray applicator may comprise a secondary air outlet that is in fluid communication with the air pressurising device and is configured for varying a spray pattern (i.e. fan shape) of liquid spray from the liquid outlet. The secondary air outlet may control the fan shape to be round or flat. That is, a round spray pattern results in a coated area that is round and the flat spray pattern results in a coated area that is linear. The secondary air outlet may therefore be provided downstream of the primary air outlet. The liquid outlet may be provided upstream of the primary air outlet.

The spray applicator may comprise the control valve. The control valve may be a primary regulator to control the flow rate of air towards the primary air outlet. The spray applicator may comprise a secondary regulator to control the flow rate of air towards the secondary air outlet. The primary and secondary regulators may be independently controlled. The primary and secondary regulators may be concentric.

The regulator may be operable to control a pressure of air at the secondary air outlet to be at least 10% greater than a pressure of air at the primary outlet. Suitably, the pressure at the secondary air outlet is at least 25% greater than a pressure of air at the primary outlet. For example, the pressure at the secondary air outlet may be from 20% to 40% greater than a pressure of air at the primary outlet. The pressure at the secondary air outlet may be from 25% to 33% greater than a pressure of air at the primary outlet. When the pressure at the primary air outlet is about 0.62 bar, the pressure at the secondary air outlet is suitably between 0.75 bar and 0.85 bar.

The trigger may be depressible. The trigger may be depressible towards a handle of the spray applicator. The trigger may be biased away from a main body of the spray applicator by a biasing means. The biasing means may be a resilient member. The resilient member may be a spring, for example a compression spring. The main body may have a gripping portion for being gripped by a user's hand. The trigger may be moved from a resting position to a pre-loading position before the outlet valve is activated. This may allow for unwanted movement of the trigger to be absorbed without the release of liquid from the spray applicator. Therefore, the movement between the resting position and pre-loading position is suitably a non-activation event.

The air pressurising device may be or comprise a compressor. The compressor may be electronically operated. The air pressurising device may be connected to an energy store for providing energy to operate the compressor, for example a battery. Alternatively, or additionally, the air pressurising device may be operable by mains electricity. A first air transmission line may be connected between the compressor and the air inlet of the receptacle. A second air transmission line may be connected between the compressor and the spray applicator. A control unit may be interposed between the compressor and the air inlet of the receptacle. At least one of the transmission lines may be or comprise a hose, which may be flexible.

The liquid may be a coating, such as a paint or varnish. The liquid may be a lacquer. The paint may be an acrylic paint or an alkyd paint. For example, the paint or varnish may be a solvent or water based lacquer. Suitable lacquers may include oxidative drying solvent or water based acrylic or alkyd lacquers.

It is a further aim to provide a method of using a liquid spray system. The method comprises the step of filling a reservoir of a receptacle with liquid. The method further comprises loading the receptacle into a support structure. The method further comprises supplying gas to a displacement member of the receptacle from a gas pressurising device. The method further comprises moving the displacement member relative to a main body of the receptacle with gas supplied by the gas pressurising device. That is, the gas pressurising device provides the motive force for moving the displacement member. The method further comprises guiding liquid from the reservoir towards a spray applicator, activating a trigger of the spray applicator and propelling liquid from an outlet valve of the spray applicator using gas from the gas pressurising device as propellant.

Suitably, the step of filing the reservoir with liquid is performed during manufacture of the receptacle and the receptacle is provided as a cartridge. That is, suitably a receptacle cannot easily be filled by an end-user. The step of filling the reservoir may comprise expanding the reservoir in proportion to the increase in received liquid volume. That is, the reservoir may have a smaller first (or pre-filled) volume compared to a second (or filled) volume. Suitably, the step of filling the reservoir comprises opening a one-way valve. Suitably an air inlet of the receptacle comprises the one-way valve. Suitably, the one-way valve is kept open while the reservoir is filled.

The step of loading the receptacle into the support structure may comprise loading the receptacle along guiding means. The guiding means may be guiding rails. The guiding means may conform to a shape of an outer wall of the receptacle. The step of loading the receptacle into the support structure may comprise loading the receptacle until a gripping means is engaged. The gripping means may be biased toward a central space in which the receptacle is loaded. The gripping means may be moved under pressure. The pressure may be overcome by hand when pushing the receptacle into the support structure by hand.

The gas pressurising device may be or comprise a compressor. The compressor may be powered by mains electricity or by a battery. The gas may be supplied to a gas inlet of the receptacle. The gas inlet may be in fluid communication with a gas side of the displacement member.

The method may comprise disturbing a tamper-proofing means comprised by the cartridge. Advantageously, a cartridge can remain closed until used by an end-user. The method may comprise disturbing the tamper-proofing means during loading the cartridge into the support structure. Advantageously, a separate step of removing the tamper-proofing means is not required which is more convenient for an end-user. A single action of loading the cartridge results in the tamper-proofing means being overcome.

Suitably, the method comprises the step of releasing gas from a gas side of the displacement member using a pressure relief valve for equalising pressure with ambient air. The gas may comprise air.

The method may comprise wearing the support structure. Alternatively or additionally, the support structure may comprise a ground contacting part and a receptacle holding part and the method may comprise moving the ground contacting part relative to the receptacle holding part so that the receptacle holding part is guided over ground. The ground contacting part may comprise at least one wheel. Suitably, the ground contacting part may comprise a plurality of wheels for stability. Therefore, the support structure may be provided in the form of a trolley.

The liquid spray system may be used in conjunction with a vehicle. The liquid spray system may be at least partially or wholly mounted on or in the vehicle. The entire liquid spray system may be mounted on or in the vehicle. The spray applicator may be mounted on an arm of the vehicle, suitably an extendable arm of the vehicle. The vehicle may be a motorized vehicle.

The method may comprise using the liquid spray system in conjunction with an unmanned aerial vehicle (UAV), such as a drone. The liquid spray system may be at least partially or wholly mounted on or in an unmanned aerial vehicle (UAV). The entire liquid spray system may be mounted on or in an unmanned aerial vehicle (UAV).

The spray applicator may be mounted on or in an unmanned aerial vehicle (UAV). The spray applicator may be mounted on or in an unmanned aerial vehicle (UAV), while the receptacle for holding liquid may be mounted not on the unmanned aerial vehicle (UAV). The receptacle for holding liquid may be connected to the UAV mounted spray applicator by one or more delivery conduits. The delivery conduits suitably being operable to deliver the liquid spray and pressured air from the air pressurizing device. Suitably, such an arrangement allows for the UAV to administer the liquid spray at a position remote from the receptacle for holding liquid.

The method may further comprise operating the unmanned aerial vehicle (UAV) under remote control by a human operator or autonomously by onboard sensors/computers.

The liquid may be a coating composition, such as a paint or varnish. The liquid may be a lacquer. The paint may be an acrylic paint or an alkyd paint. For example, the paint or varnish may be a solvent or water based lacquer. Suitable lacquers may include oxidative drying solvent or water based acrylic or alkyd lacquers.

A kit of parts or assembly for a liquid spray system may be provided. The kit of parts may comprise a cartridge filled with liquid for spraying, a spray applicator, an air pressurising device and a support structure for supporting the cartridge. Each of the parts may correspond to the corresponding component part as previously described.

As used herein, unless otherwise expressly specified, all numbers such as those expressing values, ranges, amounts or percentages may be read as if prefaced by the word “about”, even if the term does not expressly appear. Also, any numerical range recited herein is intended to include all sub-ranges subsumed therein

All of the features disclosed herein may be combined with any of the above aspects and in any combination.

### BRIEF DESCRIPTION OF DRAWINGS

For a better understanding of the disclosure, and to show how examples may be carried into effect, reference will now be made to the accompanying drawings in which:

FIG. 1 shows a perspective view of a user spraying a surface with a first example of a spray system, wherein a support structure of the spray system is floor-standing and not wearable on the user;

FIG. 2 shows a cross-sectional view of the receptacle of FIG. 1;

FIG. 3 shows a perspective view of the support structure of FIG. 1 wherein a hatch of the support structure is in an open position for accessing a receptacle shown as a cartridge housed by the support structure;

FIG. 4 shows the support structure of FIG. 3 alternatively housing a second cartridge of relatively smaller volume than the cartridge shown in FIG. 3 wherein the hatch is in a closed position;

FIG. 5 shows the main unit of FIG. 3 wherein the support structure comprises a control unit which is attachable to a receptacle holding part of the support structure;

FIG. 6 shows a second example of the spray system, wherein a support structure of the second example comprises a floor contacting part comprising wheels;

FIG. 7 shows a receptacle holding part of the support structure of the second example for housing a plurality of cartridges;

FIG. 8 shows a control unit of the second example attached to a user;

FIG. 9 shows a third example of the spray system, wherein a support structure and a control unit are wearable on a user, wherein an air pressuring device is floor-standing and not wearable on the user;

FIG. 10 shows a fourth example of the spray system, wherein a support structure and an air pressurising device powered by an energy storage unit are wearable on a user;

FIG. 11 shows the support structure and air pressurising device of FIG. 10;

FIG. 12 shows alternative examples of the support structure;

FIG. 13 shows a control unit of the fourth example;

FIG. 14 shows a flow chart of a method of using a liquid spray system;

FIG. 15 is a perspective view of a fifth example of the spray system;

FIG. 16 is an enlarged perspective view of an upper rear portion of the support structure of structure of the spray system of FIG. 15;

FIG. 17 is an enlarged perspective view of a lower side portion of the support structure of the spray system of FIGS. 15 and 16; and

FIG. 18 is a perspective view of the spray system of FIG. 15-17 with the hatch open.

FIG. 19 shows a backpack mounting board of the spray system of FIG. 15-18;

In the drawings, corresponding reference characters indicate corresponding components. The skilled person will appreciate that elements in the figures are illustrated for simplicity and clarity and have not necessarily been drawn to scale. For example, the dimensions of some of the elements in the figures may be exaggerated relative to other elements to help to improve understanding of various examples of the invention. Also, common but well-understood elements that are useful or necessary in a commercially feasible example are often not depicted in order to facilitate a less obstructed view of these various examples.

### DESCRIPTION

At least some of the following examples provide an improved liquid spray system, method of using a liquid spray system and kit of parts for a liquid spray system. The example system is simple and convenient for the user. Additionally, the effect of splashback and overspray is reduced. Other advantages and improvements will be discussed in more detail herein.

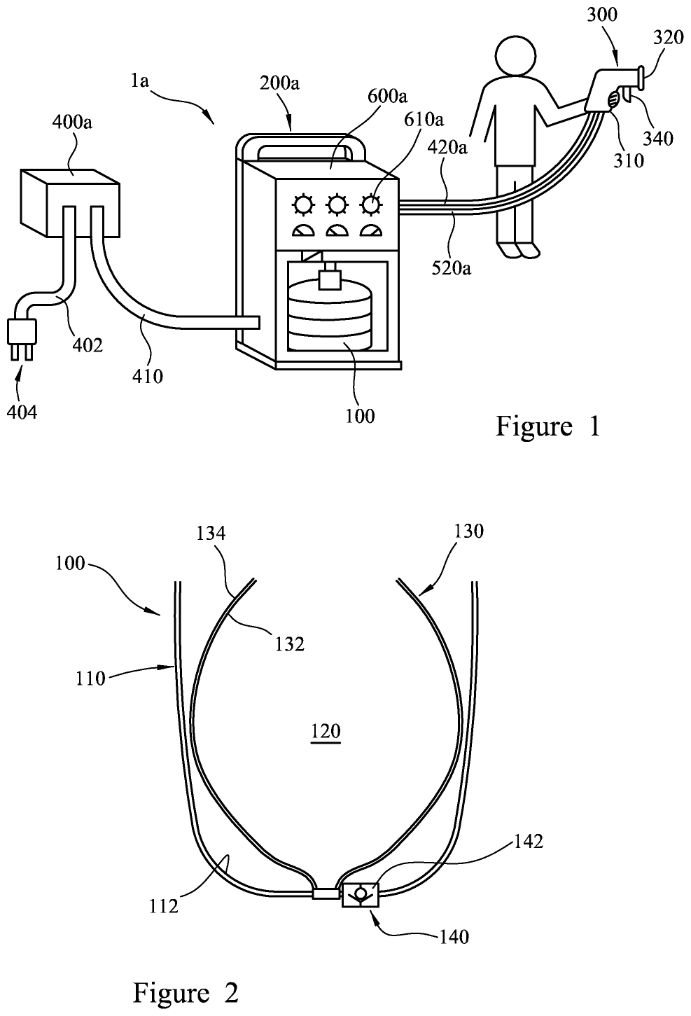

A spray system 1a according to a first example is shown in FIG. 1. The spray system comprises a receptacle 100 for containing liquid to be sprayed onto a surface. The receptacle is shown as a bottle in the form of a cartridge. Using a cartridge is advantageous because the liquid can be easily changed, particularly when the liquid remaining in the receptacle is low. The cartridge may comprise a tamper-proofing means (not shown). The tamper-proofing means may be disturbed when inserting the cartridge. Alternatively, the tamper-proofing means may be removed manually by a user before inserting the cartridge. In FIG. 1, a cylindrical receptacle is shown. The capacity of the receptacle is 2 L, although a smaller (e.g. 1 L) receptacle can be equally used. Advantageously, the support structure is capable of holding cartridges of varying capacity and/or size.

The receptacle 1a shown in FIG. 1 is installed in a support structure 200a. The support structure is a floor-standing support structure. That is, the support structure has a predetermined resting position. The resting position equates to a vertical orientation of the receptacle when installed in the support structure.

The spray system 1a further comprises a spray applicator 300 that is holdable by the hand of the user. The spray applicator comprises a trigger 340 for activating the release of the liquid away from a liquid outlet valve (not shown) of the spray applicator. The trigger is suitably biased towards a first position that is a non-activating position. The biasing means may be a resilient member such as a spring. The spray applicator is a spray gun. The spray applicator has a liquid outlet 320 that is arranged at an opposite end to a liquid inlet 310.

The spray system 1a comprises an air pressurising device 400a in the form of a compressor. The compressor supplies the receptacle 100 with air pressure so that the liquid can be driven out of the receptacle and towards the spray applicator 300. The compressor is shown to be powered by mains electricity and comprises an electrical connector 404 that supplies electricity through an electrical cable 402. However, the air pressurising device may be a canister of pressurised air. The canister is advantageous because it is portable and can be easily used outside without the risk of electrical shock. Furthermore, the compressor may be powered by a battery rather than mains electricity. It will, however, be appreciated that in some examples the spray system 1a may be supplied without an air pressurising device 400, so that a user can connect a separately obtained air pressurising device to the spray system 1a.

In one example, the air pressurising device 400a is configured to supply air at a pressure of 3 bar or less to the spray applicator 300 and/or the receptacle 100. The use of a relatively low pressure reduces overspray and splashback. This may be possible because the air pressurising device 400 is also configured to force liquid out of the receptacle 100 as discussed below.

The spray system 1a is further shown with transmissions lines 410, 420a, 520a. The transmission lines are hoses that convey air or liquid around the spray system. For example, a first air transmission line 410 provides fluid communication between the compressor and the receptacle 100. A second air transmission line 420a and a first liquid transmission line 520a fluidly link the receptacle and the spray applicator 300. A three-way connector may separate the first and second air transmission lines so that air supplied under pressure from the compressor is diverted from the first air transmission line towards the receptacle to drive a displacement member 130 of the receptacle and force liquid out of the receptacle.

As will be appreciated from the figures, the spray applicator 300 is disposed remotely from the support structure 200a holding the receptacle 100. In other words, the spray applicator 300 and the support structure 200a are separate, independently movable bodies connected by virtue of the transmission lines 420a,520a, and thus are able to move relative to one another when the spray system 1a is in use. Accordingly, the spray applicator 300 does not comprise the receptacle 100. This allows a user to move and manipulate the spray applicator 300 whilst the receptacle 100 and support structure 200a remain in position resting on the floor.

The first liquid transmission line 520a and/or the second air transmission line 420a are of a sufficient length that allows support structure to remain in position (e.g. on the floor or worn by a user) whilst the spray applicator 300 is moved by the user. For example, the transmission lines 520a/420a may be at least 0.5 m long, e.g. 2 m or 3 m.

Finally, a control unit 600a with control dials 610a is shown that is attached to the support structure 200a. Although three control dials are shown, at least one control dial may be used to simplify the options for adjustment. The control unit is removable from the support structure. That is, the control unit can be coupled and decoupled to the support structure. This allows the control unit to be removed for maintenance, repair or update.

The receptacle 100 is shown in cross-section in FIG. 2. The receptacle comprises a main body 110 that is an outer part of the receptacle. The main body may be made from metal or plastic. The receptacle further comprises a displacement member 130 that is provided as a bladder. The displacement member is configured to expand and contract as liquid fills and leaves (through a liquid outlet (not shown) of) a reservoir 120, respectively. In the example shown, the reservoir is provided by the displacement member alone and not the main body. However, in an alternative example, the reservoir 120 may be formed by the main body and the displacement member, for example, if the displacement member is provided as a piston. The displacement member therefore has an air contacting side 134 and a liquid contacting side 132. The main body also has an air contacting side 112 that comes into contact with the displacement member. To allow the displacement member to move freely away from the air contacting side of the main body, the air contacting side comprises a coating that is a non-stick coating to avoid the adhesion of the displacement member to the main body.

FIG. 2 further shows an air inlet 140. The air inlet allows air to enter the receptacle 100 from the compressor. The air contacts the air contacting side 112 of the main body 110 and the air contacting side 134 of the displacement member 130 to force the displacement member to move. In the example shown, the displacement member is a bladder and comprises a flexible membrane allowing the displacement member to be manipulated so that the displacement member can expand and contract by air pressure.

In one example, the air inlet comprises a one-way valve 142 for restricting air flow and preventing air flow out of the receptacle. This prevents the reservoir 120 being filled without circumventing (i.e. overcoming) the one-way valve because the displacement member is prevented from expanding when liquid enters the reservoir. Advantageously, the cartridge may not be refillable by the user without a special tool to open the one-way valve. However, in other examples, the air inlet 140 comprises an aperture that is not restricted by a one-way valve. In such examples, the pressure is equalised when the air inlet is disengaged from the spray system 1a.

In one example, the liquid outlet and air inlet 140 are disposed at or towards opposing ends of the receptacle 100. For example, the liquid outlet may be disposed at a top portion of the receptacle 100, and the air inlet 140 may be disposed at a bottom portion of the receptacle 100, such as on an underside of the receptacle 100.

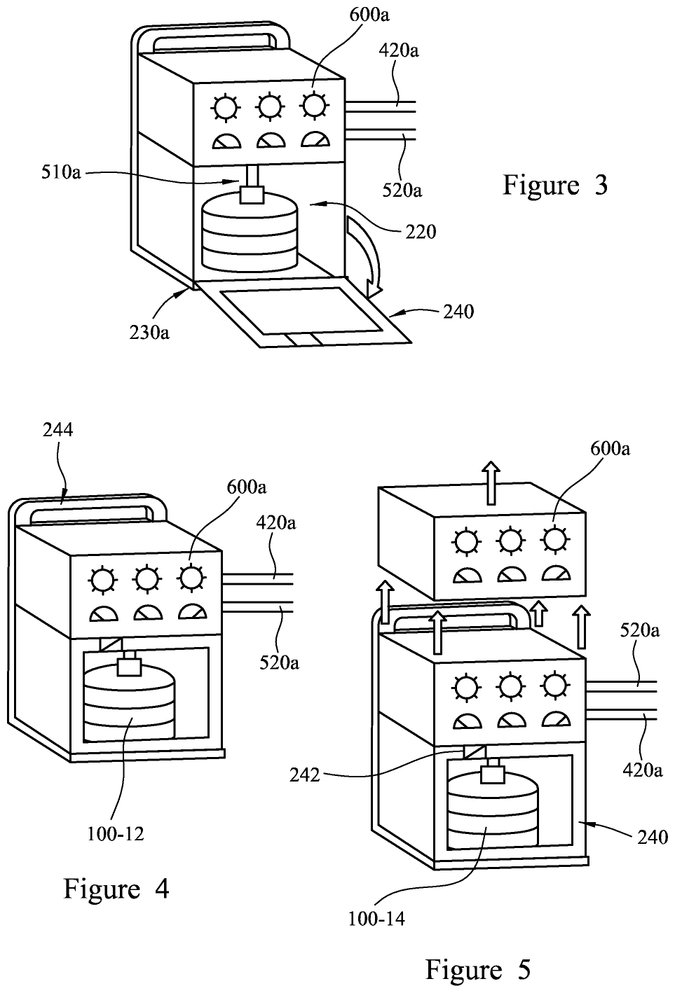

The support structure 200a of the first example is shown in more detail in FIGS. 3 to 5. As previously mentioned, the support structure is shown with a removable control unit 600a that regulates the flow of air and/or liquid of the spray system 1a. Transmissions lines 420a, 520a are shown to transport the air and liquid around the system. Furthermore, cartridge 100-12 and cartridge 100-14 of differing capacities are shown. The support structure comprises a handle 244 for ease of transportation. The cartridge is removed by opening a door 240, shown as a hatch. The door may comprise a window for visual inspection of the inside of the support structure. The door comprises an opening means 242. The opening means may be a handle. However, suitably the opening means is a button to release the hatch. The door is hinged to allow the door to pivot and provide an opening through which to pass the receptacle 100. The support structure 200a comprises an accommodating part 220 for receiving the receptacle (i.e. housing the receptacle) and a ground contacting part 230a for abutment against a ground surface. The accommodating part is therefore a receptacle holding part 220. A further liquid transmission line 510a is shown that is arranged to convey liquid from the receptacle to the control unit.

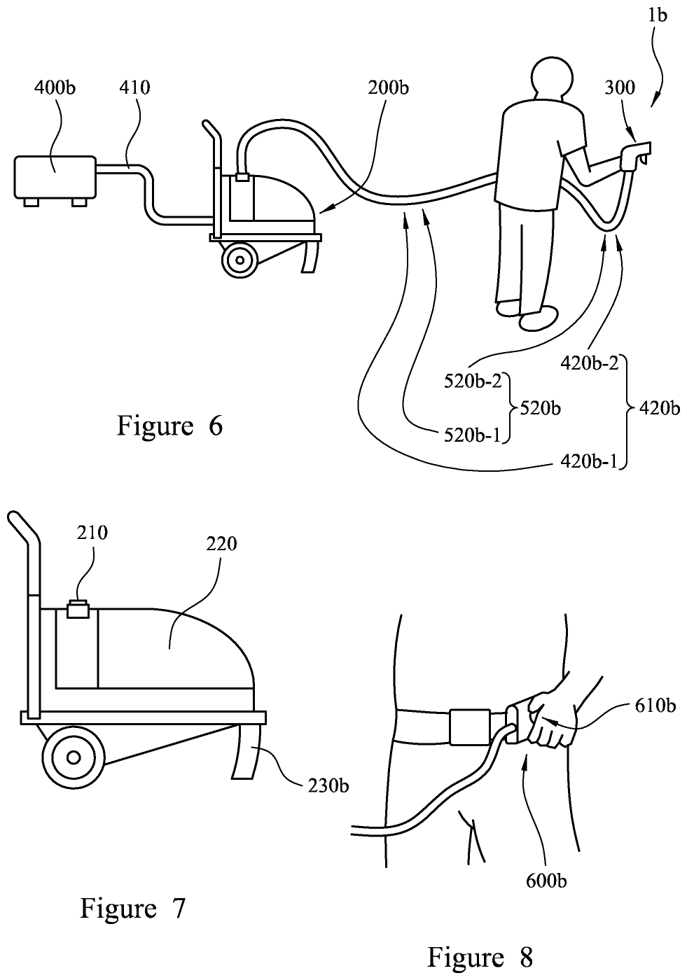

A spray system 1b according to a second example is shown in FIG. 6. The spray system of the second example differs from the spray system 1a of the first example in that the air pressurising device 400b is powered by liquid fuel, such as diesel or gasoline, the support structure 200b is arranged in the form of a trolley and the control unit 600b (see FIG. 8) is wearable on the user.

A first air transmission line 410 connects the air pressurising device 400b and the support structure 200b. Although not shown, a first liquid transmission line 510b is connected between a liquid outlet portion of the reservoir 120 and a connecting member 210 shown in FIG. 7. A second liquid transmission line 520b is configured to transmit liquid away from the connecting member and toward the liquid inlet 310 of the spray applicator 300. Similarly, a second air transmission line 420b is configured to transmit air from the connecting member and toward the spray applicator to propel liquid out of the liquid outlet valve of the spray applicator. Both the second liquid transmission line and the second air transmission line comprise a pair of transmission sub-lines. A first air transmission sub-line 420b-1 is connected upstream of the control unit 600b and a second air transmission sub-line 420b-2 is connected downstream of the control unit. Likewise, a first liquid transmission sub-line 520b-1 is connected upstream of the control unit and a second liquid transmission sub-line 520b-2 is connected downstream of the control unit. A control dial 610b is used to control the passage of liquid and/or air.

The support structure 200b comprises a telescopic handle for ease of storage. The support structure comprises a receptacle holding part 220 (i.e. an accommodating part) and a ground contacting part 230b. Unlike the support structure 220a of the first example, the support structure of the second example is capable of holding a plurality of receptacles 100 at once. The receptacle holding part comprises a door that allows access to the inside of the receptacle holding part (i.e. the region accommodating the at least one receptacle). The door does not comprise a window. The ground contacting part comprises a plurality of wheels. The wheels may be connected by a common axle. Alternatively, the wheels may rotate independently and therefore have separate axles. The ground contacting part further comprises a foot provided away from the wheels. The foot does not move relative to the receptacle holding part but is configured to rest against a ground surface when the support structure is in a standing position.

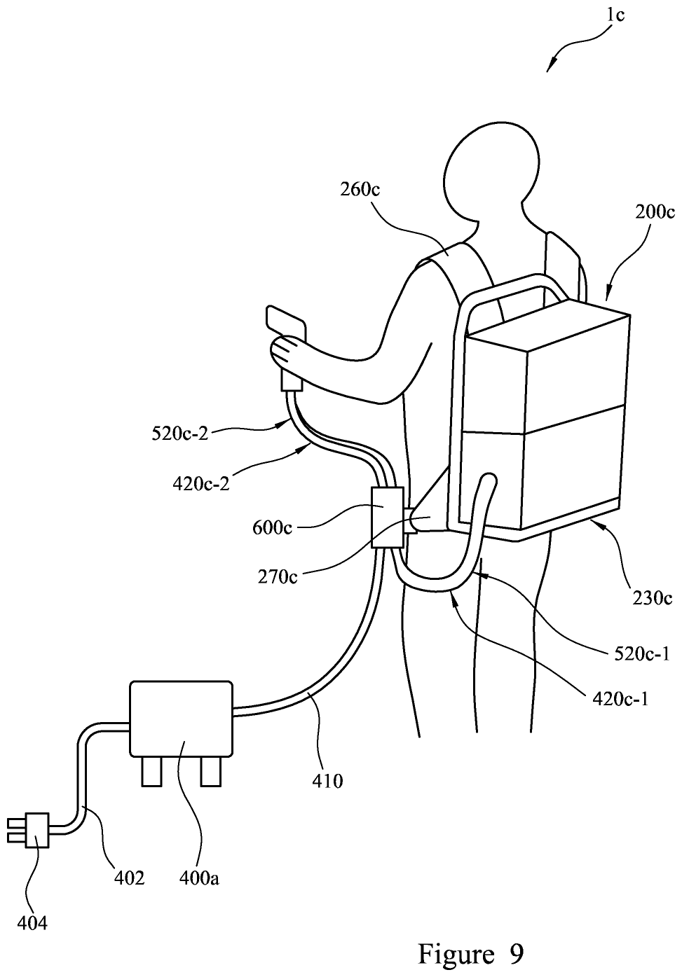

A spray system 1c according to a third example is shown in FIG. 9. The spray system differs from the spray system 1a of the first example in that the support structure 200c and control unit 600c are both wearable on a user (the support structure comprises a ground contacting part 230c for resting the support structure on ground in a resting position). The support structure is worn by the user using shoulder straps 260c and the control unit is worn using a belt 270c. The air pressurising device 400a of the first example is shown. However, the air pressurising device 400b of the second example can equally be used. The air pressurising device is powered by mains electricity and comprises an electrical connector 404 that supplies electricity through an electrical cable 402.

The first air transmission line 410 of the third example is connected between the air pressurising device 400a and the control unit 600c. The control unit therefore acts as a hub about which the network of transmission lines is arranged. A second air transmission line 420c comprises a first air transmission sub-line 420c-1 which transmits air towards the receptacle 100 and a second air transmission sub-line 420c-2 transmits air towards the spray applicator 300. Additionally, a first liquid transmission line 520c comprises a first liquid transmission sub-line 520c-1 which transmits liquid from the receptacle 100 to the control unit and a second liquid transmission sub-line 520c-2 transmits liquid from the control unit to the spray applicator. Therefore, the first and second liquid transmission sub-lines flow in and out of the control unit whereas the first and second air transmission sub-lines both flow out of the control unit since the first air transmission line supplies the control unit with air from the air pressurising device.

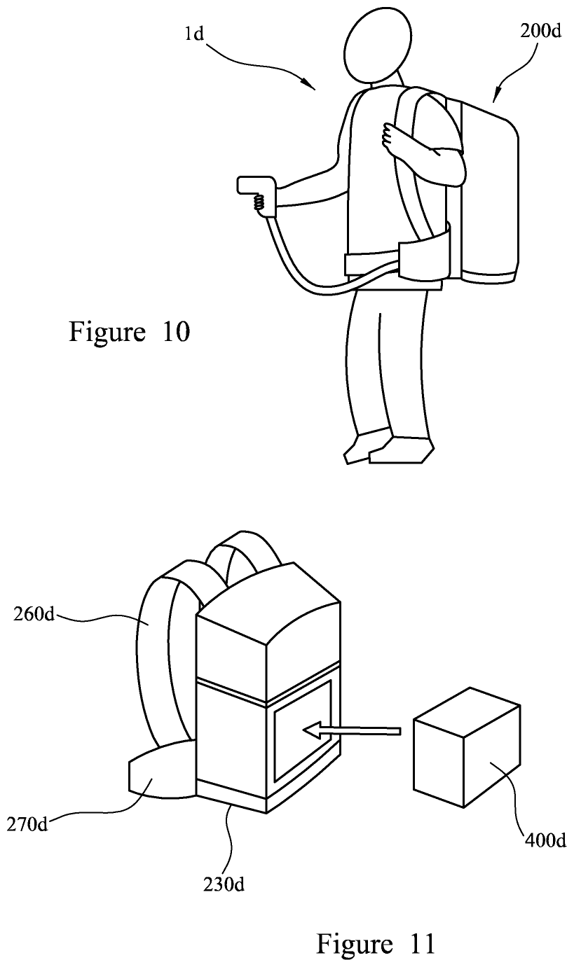

A spray system 1d according to a fourth example is shown in FIG. 10. The spray system of the fourth example is similar to the spray system 1c of the third example in that the support structure 200d and control unit 600d (including at least one control dial 610d as shown in FIG. 13) are both wearable on a user. The support structure is provided as a backpack. The backpack includes shoulder straps 260d and a belt 270d. The air pressurising device 400d of the fourth example is powered by a battery. This allows the spray system to be portable and the air pressurising device can be carried by the user. The support structure comprises a plurality of compartments, each for the receptacle and the air pressurising device with battery. A lower compartment is the ground contacting part 230d.

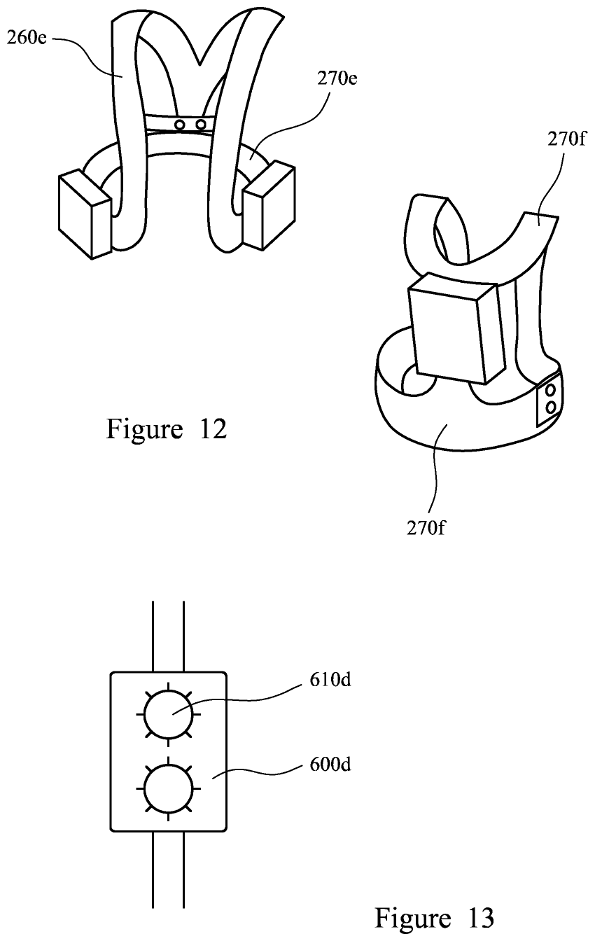

FIG. 12 shows two variations of the shoulder straps 260e, 260f and belt 270e, 270f combination of FIGS. 9 and 10. These variations comprise holders for further receptacles 100 or generally pockets for storing other items of use. The shoulder straps and belt are comfortable and convenient for a user.

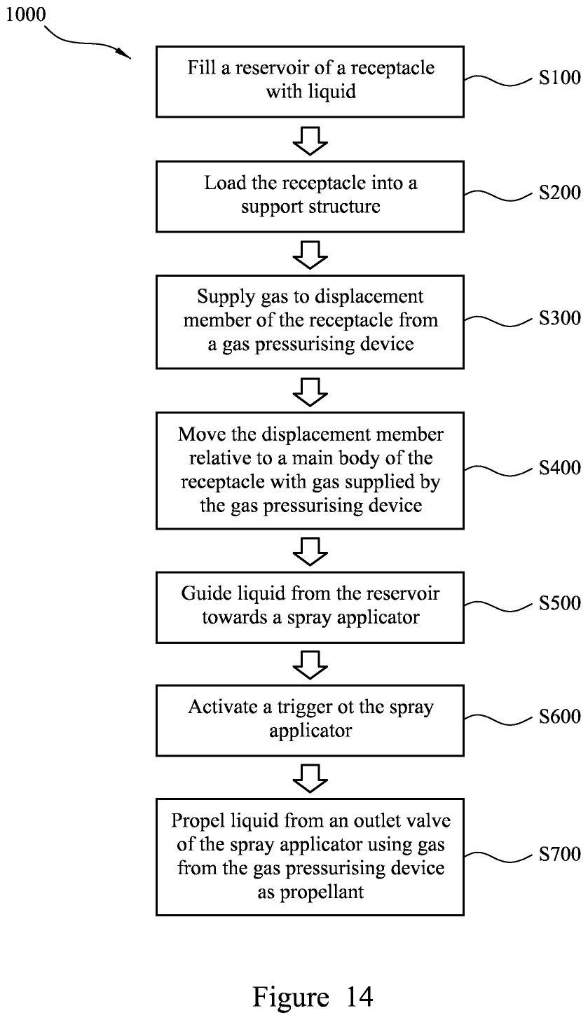

FIG. 14 shows a method 1000 of using a liquid spray system. The method includes filling the receptacle with liquid (S100), suitably a coating composition such as a paint or varnish. The filling step may be performed using a one-way valve so that an end-user cannot easily re-fill the receptacle because the one-way valve may require a special tool to overcome. Once the receptacle is filled, the receptacle can be loaded into a support structure (S200). When the receptacle comprises a tamper-proofing means, the step of loading the receptacle may disturb the tamper-proofing means and allow the liquid to be released from the receptacle. Once the receptacle is loaded, gas is supplied to a displacement member of the receptacle from a gas pressurising device (S300). The gas pressurising device may be a compressor and the gas may be air. The supply of gas under pressure results in the movement of the displacement member relative to a main body of the receptacle (S400). The displacement member therefore acts as a bladder and expands and contracts under pressure. As a result of the movement of the displacement member, liquid is guided from the reservoir towards a spray applicator (S500). To release the liquid from the spray system, a trigger on the spray applicator is activated (S600), suitably by hand. The liquid is then propelled from an outlet valve of the spray applicator using gas from the gas pressurising device as a propellant (S700). The liquid can be directed to a surface to be coated. Once a liquid level in the receptacle is sufficiently low, the receptacle can be replaced. Therefore, it is convenient if the receptacle is a cartridge so that the receptacle can be swapped with ease.

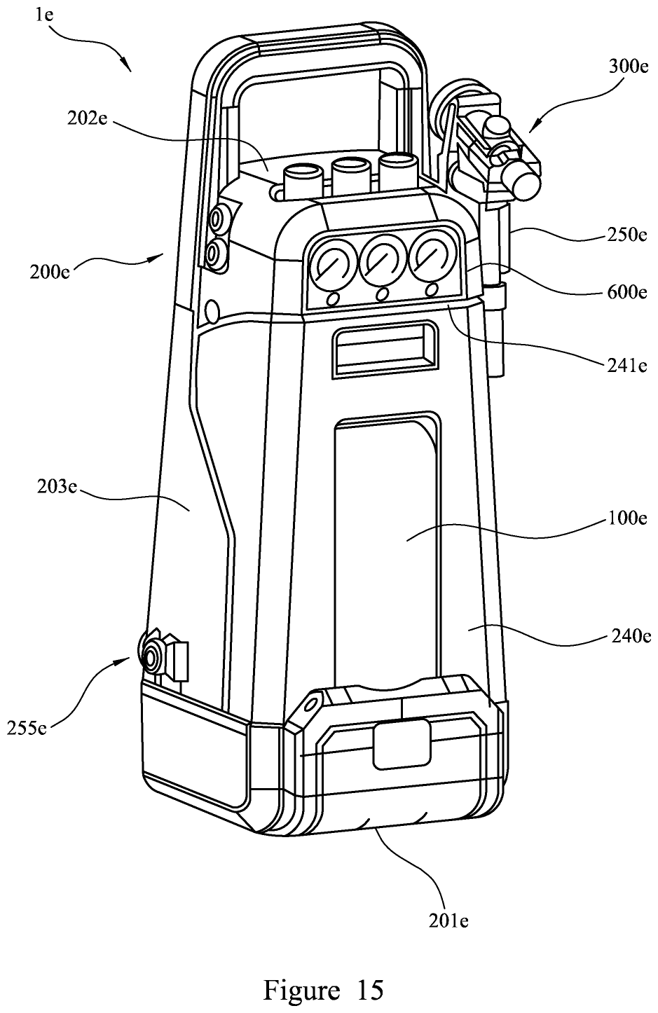

A further example of a liquid spray system 1e is shown in FIGS. 15-19. The liquid spray system 1e corresponds largely in structure and function to the liquid spray systems 1a-1d described herein, and therefore only the differences will be discussed in detail. Furthermore, FIGS. 15-19 omit the transmission lines and air pressurising device so as to facilitate an unobstructed view of the features of the system 1e.

As can be best seen in FIGS. 15-18, liquid spray system 1e comprises a support structure 200e, configured to retain a receptacle 100e. Similarly to the support structure 200a, the support structure 200e takes the form of a generally cuboid structure, albeit with the base 201e of the support structure 200e having a larger surface area than the top 202e. The generally vertical sidewalls 203e of the support structure 200e have a longer vertical extent than the horizontal extent of the top 202e and bottom 201e, so that the support structure 200e has a generally “portrait” orientation when viewed from the front or side. Similarly to the support structure 200d, the support structure 200e is configured so that it can be either worn on the back of the user or rested on the floor or another support surface in use. In other words, the support structure 200e is operable in two configurations, a worn configuration and a floor-resting configuration.

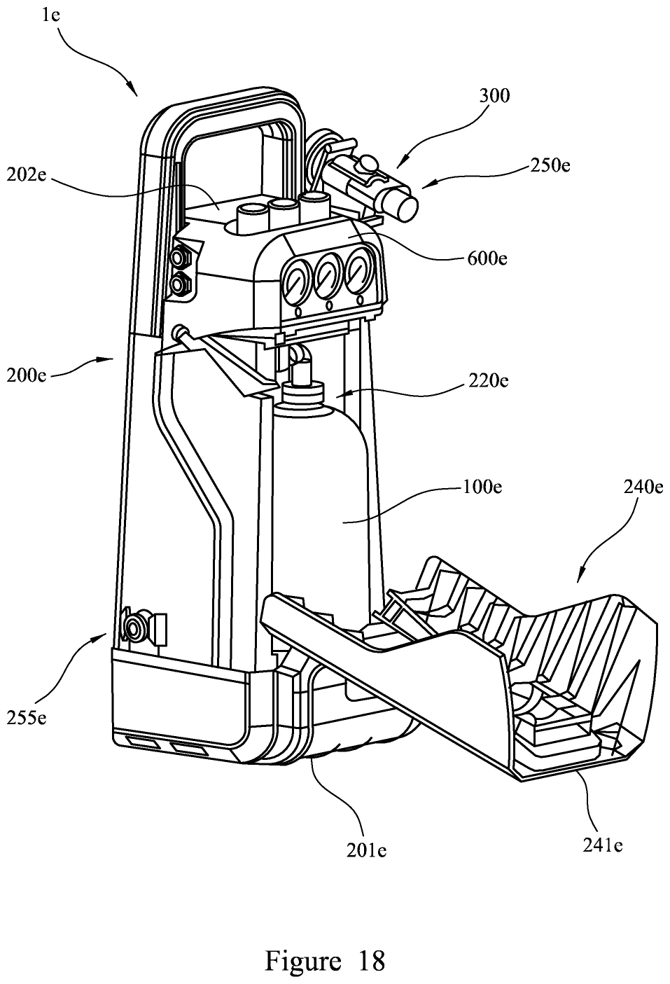

The support structure 200e defines a housing or enclosure that has an internal volume that accommodates the receptacle 100e. This enclosure is accessible by opening the door 240e. As can be best seen in FIG. 18, the door 240e is pivotally attached to the support structure 200e towards the base 201e, so that the upper edge 241e of door 240e can move away from and forward of the support structure 200e.

The internal volume of the support structure 200e comprises an accommodating part 220e that is configured to retain the receptacle 100e. The accommodating part 220e is shaped to engage with the receptacle 100e so as to hold it securely in position during operation of the spraying system 1e. For example, the accommodating part 200e may take the form of recess having a shape that is at least partially complementary to the shape of the receptacle 100e, so as to securely engage the main body of the receptacle 100e.

It will be appreciated that the recess may not exactly correspond to the shape of the receptacle 100e—for example the recess may be able to accommodate expansion of the receptacle 100e in use. Furthermore, it will be appreciated that in some examples the accommodating part 200e comprises elements on the interior surface of the door 240e that are configured to engage with the receptacle 100e when the door 240e is closed.

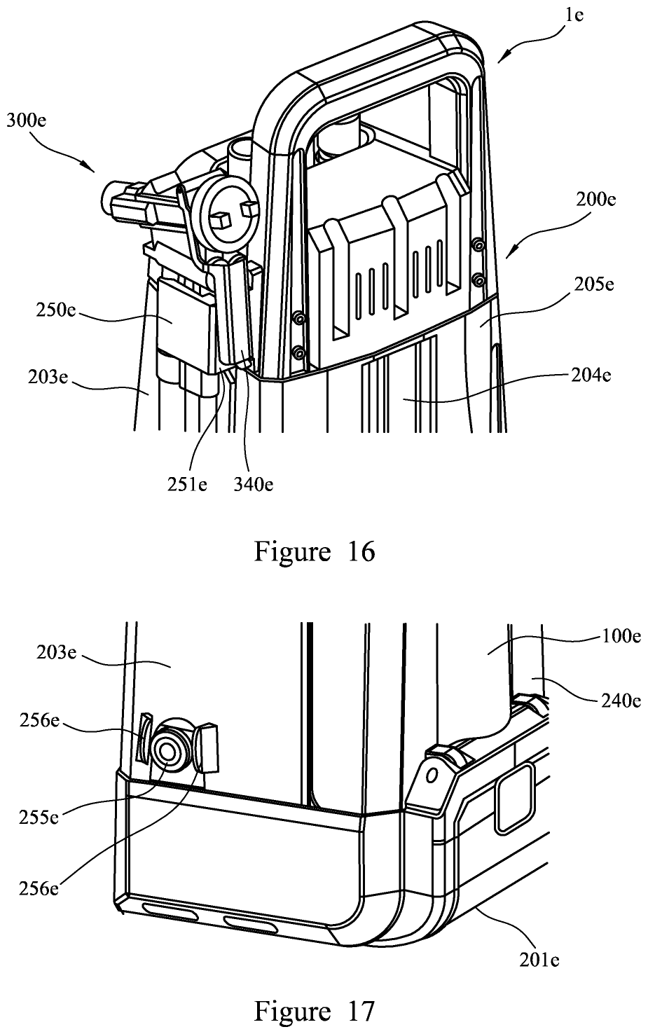

In one example, the support structure 200e comprises a spray applicator holder 250e, configured to retain the spray applicator 300e when not in use. The spray applicator holder 250e is located at an upper portion of one of the sidewalls 203e. Furthermore, the holder 250e comprises a stop member 251e (best seen in FIG. 16), which prevents activation of the trigger 340e of the spray applicator 300e, when the spray applicator is in the holder 250e. For example, stop member 251e is a projection that extends between the trigger 340e and a handle 330e of the spray applicator 300e. Accordingly, the stop member 251e prevents the trigger 340e being depressed towards the handle 330e, thereby preventing activation of the trigger 340e.

In one example, the system 1e comprises an emergency cut off button 255e, which is shown in detail in FIG. 17. For example, the emergency cut off button 255e is disposed at a lower portion of one of the sidewalls 203e. Accordingly, when the support structure 200e is worn on the back of the user, the user can easily reach the button 255e to activate it. The emergency cut off button 255e is configured to cut off the air supply received from the air pressurising device 400 upon activation of the button, for example by activating a shut-off valve. Consequently, liquid will no longer be forced out of the receptacle 100e, and the spray applicator 300e will no longer propel the liquid therefrom.

In one example, a guard portion is positioned around the emergency cut off button 255e. The guard portion extends further from the sidewall 203 than the button 255e, so as to prevent accidental activation of the button 255e. In one example, the guard portion takes the form of a pair of projections 256e arranged at opposite sides of the button 255e.

The receptacle 100e takes the form of a generally cylindrical main body 110e, with a domed top portion 111e. A neck 112e is formed at the peak of domed top portion 111e, wherein the neck forms the liquid outlet of the receptacle 100e

The bottom end 113e, which is disposed at the opposite end of the main body 110e to the top portion 111e, comprises the air inlet 140e. In one example, the air inlet 140e is arranged on the underside 114e of the receptacle 100e.

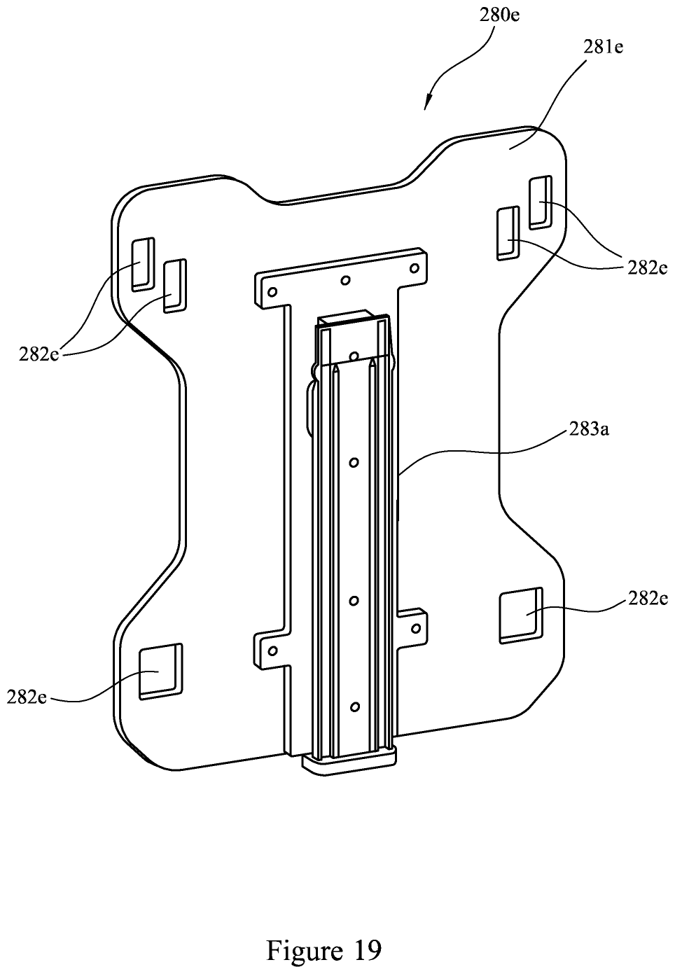

Turning now to FIG. 19, there is shown an exemplary backpack mounting unit 280e. The backpack mounting unit 280e comprises a board 281e having a plurality of apertures 282e, which are configured to retain suitable shoulder and hip straps (not shown). The backpack mounting unit 280e is connectable to the rear of the support structure 200e, for example via mounting rail 283e, which is slidably engageable in a corresponding recess 204e disposed on a rear side wall 205e of the support structure 200e. This allows the support structure 200e to be rapidly converted from a floor standing support structure to a wearable support structure.

Whilst the liquid stored in the receptacle 100 described above may be a liquid for coating a surface, it will be appreciated that a receptacle 100 comprising a cleaning solution for cleaning the system 1 may also be supplied. Particularly, some liquids used by the spraying system 1 may dry and set in the liquid transmissions lines of the system 1 when the system 1 is stored between uses. Accordingly, a receptacle 100 comprising a cleaning solution may be received in the system 1, such that the cleaning solution may be drawn through the system 1 in order to flush the system 1.

In summary, examples of a liquid spray system and method of using a liquid spray system have been described. The described examples offer improvements over known systems and methods. The spray system of the examples is convenient to manufacture and straightforward to use. Furthermore, the spray system of examples is easy to transport and accurate to apply a liquid to a surface to be coated by the liquid.

In addition, the fact that the receptacle is disposed remotely from the spray applicator (e.g. with the receptacle in a floor standing or backpack-worn configuration) allows for a relatively large reservoir of liquid to be used. This increases the time taken to exhaust the liquid in the reservoir, and thus extending the time between replacement of the receptacle. Accordingly, user convenience is improved. Furthermore, the use of fewer, larger receptacles reduces the ratio of liquid to packaging, reducing packaging costs and transport costs.

Still further, the disposal of the receptacle remote from the spray applicator ensures that the spray applicator can remain relatively lightweight and easy-to-handle, allowing for a great degree of freedom of movement of the spray applicator. This advantageously assists the user in accurately dispensing the liquid, for example by accurately spraying a coating composition onto a surface.

Advantageously, the configuration of the liquid spray system allows for the liquid to be propelled from the spray applicator at a relatively low pressure. In turn, this reduces overspray and splashback, allowing the spray applicator to be placed in relatively close proximity to the surface being sprayed. Accordingly, as the distance between spray applicator and surface is minimised, the effects of environmental conditions, such as draughts and wind, are minimised. This renders the liquid spray system advantageously suitable for outdoor applications.

The spray system may be manufactured industrially. An industrial application of the example embodiments will be clear from the discussion herein.

Although preferred embodiment(s) of the present invention have been shown and described, it will be appreciated by those skilled in the art that changes may be made without departing from the scope of the invention as defined in the claims.

1. A liquid spray system (1a, 1b, 1c, 1d, 1e) comprising:
a support structure configured to support a receptacle, the receptacle (100) for holding liquid, the receptacle comprising:
a main body (110);
a reservoir (120) having a liquid outlet;
a displacement member (130) moveable within the main body for varying a capacity of the reservoir and having a liquid contacting side (132) and an air contacting side (134); and
an air inlet (140) in fluid communication with the air contacting side of the displacement member;
a spray applicator (300) disposed remotely from the support structure comprising:
a liquid inlet (310) for receiving liquid from the liquid outlet of the reservoir;
a liquid outlet (320);
a liquid outlet valve for controlling the release of liquid via the liquid outlet;
a trigger (340) for controlling the outlet valve; and
wherein the system is configured to be connected to an air pressurising device (400a, 400b, 400d) so that the air pressurising device is in fluid communication with:
the air contacting side of the displacement member, so as to move the displacement member, in use; and
the liquid outlet valve of the spray applicator, so as to propel liquid out of the liquid outlet valve of the spray applicator, in use.

2. The liquid spray system according to claim 1, wherein the support structure comprises an accommodating part configured to receive the receptacle.

3. The liquid spray system according to claim 2, wherein the accommodating part defines a recess having a shape at least partially corresponding to a shape of the receptacle.

4. The liquid spray system according to claim 2, wherein the support structure comprises an enclosure having an interior volume, the enclosure comprising the accommodating part.

5. The liquid spray system according to claim 4, wherein the support structure comprises a door configured to open and close the enclosure.

6. The liquid spray system according to claim 1, wherein the support structure is wearable on a user.

7. The liquid spray system according to claim 1, wherein the support structure is configured to be disposed on a floor or other support surface whilst the spray applicator is held in a hand of a user.

8. The liquid spray system according to claim 1, comprising a liquid transmission line extending between the support structure and the spray applicator, wherein a length of the liquid transmission line is 0.5 m or greater.

9. The liquid spraying system according to claim 1, wherein the support structure comprises a spray applicator holder, configured to retain the spray applicator when not in use, the spray applicator holder being configured to prevent activation of the trigger of the spray applicator when retaining the spray applicator.

10. The liquid spray system according to claim 1, wherein the displacement member comprises a flexible membrane.

11. The liquid spray system according to claim 1, wherein a liquid outlet portion of the reservoir and an air inlet portion of the receptacle are arranged at or towards opposite ends of the receptacle.

12. The liquid spray system according to claim 1, wherein the support structure is arranged for supporting the air pressurising device.

13. The liquid spray system according to claim 1, wherein the air pressurising device is a compressor.

14. The liquid spray system according to claim 1, further comprising the air pressurising device.

15. The liquid spray system according to claim 1, further comprising the receptacle.

16. The liquid spray system according to claim 15, wherein the receptacle comprises the liquid.

17. The liquid spray system according to claim 1, wherein the liquid is a coating.

18. A method (1000) of using a liquid spray system comprising the steps of:
loading (S200) a receptacle comprising a reservoir of liquid into a support structure;
supplying (S300) gas to a displacement member of the receptacle from a gas pressurising device;
moving (S400) the displacement member relative to a main body of the receptacle with gas supplied by the gas pressurising device;
guiding (S500) liquid from the reservoir towards a spray applicator; and
propelling (S700) liquid from an outlet valve of the spray applicator using gas from the gas pressurising device as propellant upon activation of a trigger of the spray applicator.

19. The method (1000) of claim 18, comprising filling (S110) the reservoir with liquid.

20. The method (1000) of claim 18, comprising wearing (S900) the support structure.

21. The method (1000) according to claim 18, wherein the gas comprises air.

22. The method (1000) according to claim 18, wherein the liquid is a coating composition.

23. An assembly for a liquid spray system (1a, 1b, 1c, 1d, 1e) comprising:
a support structure (200a, 200b, 200c, 200d) configured to support a receptacle, the receptacle (100) for holding liquid, the receptacle comprising:
a main body (110);
a reservoir (120) having a liquid outlet;
a displacement member (130) moveable within the main body for varying a capacity of the reservoir and having a liquid contacting side (132) and an air contacting side (134);
an air inlet (140) in fluid communication with the air contacting side of the displacement member; and
a spray applicator (300) connectable to the support structure so as to be disposed remotely therefrom comprising:
a liquid inlet (310) for receiving liquid from the liquid outlet of the reservoir;
a liquid outlet (320);
a liquid outlet valve for controlling the release of liquid via the liquid outlet;
a trigger (340) for controlling the outlet valve,
wherein the assembly is configured to be connected to an air pressurising device (400a, 400b, 400d) so as to place the air pressurising device in fluid communication with:
the air contacting side of the displacement member, so as to move the displacement member, in use; and
the liquid outlet valve of the spray applicator, so as to propel liquid out of the liquid outlet valve of the spray applicator, in use.

24. The assembly of claim 23, further comprising the receptacle.

25. The assembly of claim 24, wherein the receptacle comprises the liquid.

26. The assembly of claim 23, comprising the air pressurising device.

27. Use of a receptacle for holding a coating composition in a liquid spray system as defined in claim 1, the receptacle comprising:
a main body;
a reservoir holding a coating composition and having a liquid outlet;
a displacement member moveable within the main body for varying a capacity of the reservoir and having a liquid contacting side and an air contacting side;
an air inlet in fluid communication with the air contacting side of the displacement member.

28. The liquid spray system according to claim 17, wherein the coating is a paint or varnish.

29. The method (1000) according to claim 22, wherein the coating composition is a paint or varnish.
